(19) United States
(12) Patent Application Publication
(10) Pub. No.: US 2015/0066687 A1
(43) Pub. Date: Mar. 5, 2015

(54) USE OF E-RECEIPTS FOR CONSUMPTION TRACKING

(71) Applicant: Bank of America Corporation, Charlotte, NC (US)

(72) Inventors: Jason P. Blackhurst, Charlotte, NC (US); Matthew A. Calman, Charlotte, NC (US); Katherine Dintenfass, Charlotte, NC (US); Carrie A. Hanson, Charlotte, NC (US); Laura C. Bondesen, Charlotte, NC (US)

(21) Appl. No.: 14/535,834

(22) Filed: Nov. 7, 2014

Related U.S. Application Data
(63) Continuation of application No. 13/952,362, filed on Jul. 26, 2013.

(51) Int. Cl. G06Q 30/06

(52) U.S. Cl. CPC G06Q 30/0631
USPC 705/26.7

(57) ABSTRACT

Embodiments related to tracking consumer consumption for purchased items are provided. In some embodiments, a system is provided that receives e-receipt data, including stack keeping unit (SKU) level data, from a customer and compares the e-receipt data with transaction data. The system identifies transactions associated with one or more customer goals based on the SKU level data and calculates a first quantity of consumption for each of the identified transactions.

### CROSS-REFERENCE TO RELATED APPLICATIONS

This application is filed under the provisions of 35 U.S.C. §120 and is a continuation of U.S. patent application Ser. No. 13/952,362, filed on Jul. 26, 2013, and entitled “Use of E-Receipts for Consumption Tracking” in the name of Jason P. Blackhurst, which is incorporated herein by reference in its entirety.

### BACKGROUND

Consumers often make purchases without fully considering the quantity, quality, or choice of items they purchase. Consumer consumption that occurs as a result of these transactions often has a large impact on the purchaser's financial and personal goals. In many cases, these transactions and the impact the transactions have on personal and financial goals are so complex and numerous that purchasers may not have enough information or time to align financial activity with certain goals. Thus, information such as receipt data, shipping data, transaction data, and other data related to consumer transactions and consumption remains unutilized.

### BRIEF SUMMARY

The embodiments provided herein are directed to systems for tracking consumer consumption. In some embodiments, the systems include a computer apparatus including a processor and a memory and a tracking module stored in the memory, comprising executable instructions that when executed by the processor cause the processor to receive e-receipt data comprising stock keeping unit (SKU) level data from a customer, wherein the e-receipt data is associated with a first period of time. In some embodiments, the executable instructions further cause the processor to compare the e-receipt data with transaction data. In some embodiments, the executable instructions further cause the processor to identify transactions associated with one or more customer goals based on the SKU level data. In some embodiments, the executable instructions further cause the processor to calculate a first quantity of consumption for each of the identified transactions.

In further embodiments, the executable instructions further cause the processor to determine the level of influence that each transaction has on the one or more customer goals and assign at least one weighted value to each of the transactions based on the level of influence. In some embodiments, the executable instructions further cause the processor to provide a recommendation to the customer based on the weighted value and the one or more customer goals. In some embodiments, the executable instructions further cause the processor to identify an overlapping transaction from the transactions that is assigned two or more weighted values, wherein each of the two or more weighted values are associated with different goals and determine that the first weighted value is greater than the second weighted value. In some embodiments, the executable instructions further cause the processor to provide a recommendation to the customer based on the first weighted value. In some embodiments, the executable instructions further cause the processor to provide a recommendation to the customer based on the second weighted value.

In some embodiments, the executable instructions further cause the processor to allow the user to synchronize one or more applications with the system, import data from the one or more applications, and assign at least one weighted value to each of the transactions based on the imported data. In some embodiments, the executable instructions further cause the processor to receive customer input and identify the one or more customer goals based on the input. In some embodiments, the executable instructions further causes the processor to calculate a second quantity of consumption associated with transactions occurring during a second period of time that predates the first period of time, and compare the first quantity of consumption and the second quantity of consumption. In some embodiments, the executable instructions further cause the processor to determine that the one or more customer goals have been reached based on the comparison of the first quantity of consumption and the second quantity of consumption. In some embodiments, the executable instructions further cause the processor to determine that the one or more customer goals have not been reached based on the comparison of the quantities of consumption and provide a recommendation to the customer comprising transaction modifications.

Further provided herein are embodiments directed to a computer program product for tracking consumer consumption. In some embodiments, the computer program product comprises a computer readable storage medium having computer readable program code embodied therewith, the computer readable program code comprising computer readable program code configured to receive e-receipt data comprising stock keeping unit (SKU) level data from a customer, wherein the e-receipt data is associated with a first period of time.

In some embodiments, the computer program product further includes computer readable program code configured to compare the e-receipt data with transaction data. In some embodiments, the computer program product further includes computer readable program code configured to identify transactions associated with one or more customer goals based on the SKU level data. In some embodiments, the computer program product further includes computer readable program code configured to calculate a first quantity of consumption for each of the identified transactions.

In additional embodiments of the system, the computer program product further includes computer readable program code configured to determine the level of influence that each transaction has on the one or more customer goals and assign at least one weighted value to each of the transactions based on the level of influence. In other embodiments, the computer program product further includes computer readable program code configured to identify an overlapping transaction from the transactions that is assigned two or more weighted values, wherein each of the two or more weighted values are associated with different goals, determine that the first weighted value is greater than the second weighted value. In still other embodiments, the computer program product further includes computer readable program code configured to provide a recommendation to the customer based on the first weighted value or the second weighted value. In some embodiments, the computer program product further includes computer readable program code configured to calculate a second quantity of consumption associated with transactions occurring during a second period of time that predates the first period of time, compare the first quantity of consumption and the second quantity of consumption , determine that the one or more customer goals have not been reached based on the comparison of the quantities of consumption; and provide a recommendation to the customer comprising transaction modifications.

Further provided are embodiments directed to a computer-implemented method for tracking consumer consumption. In some embodiments, the method includes receiving e-receipt data comprising stock keeping unit (SKU) level data from a customer, wherein the e-receipt data is associated with a first period of time. In some embodiments, the method includes comparing, by a processor, the e-receipt data with transaction data. In some embodiments, the method includes identifying, by a processor, transactions associated with one or more customer goals based on the SKU level data. In some embodiments, the method includes calculating, by a processor, a first quantity of consumption for each of the identified transactions.

In some embodiments, the method includes determining, by a processor, the level of influence that each transaction has on the one or more customer goals; and assigning, by a processor, at least one weighted value to each of the transactions based on the level of influence. In some embodiments, the method includes identifying, by a processor, an overlapping transaction from the transactions that is assigned two or more weighted values, wherein each of the two or more weighted values are associated with different goals; and determining, by a processor, that the first weighted value is greater than the second weighted value. In some embodiments, the method includes calculating, by a processor, a second quantity of consumption associated with transactions occurring during a second period of time that predates the first period of time; comparing, by a processor, the first quantity of consumption and the second quantity of consumption; and determining, by a processor, that the one or more customer goals have been reached based on the comparison.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a process for tracking consumer consumption in accordance with various embodiments;

FIG. 2 is a flowchart illustrating a process for tracking consumer consumption in accordance with various embodiments;

FIG. 3 is a system and environment for tracking consumer consumption in accordance with various embodiments;

FIG. 4 illustrates the systems and/or devices in FIG. 2; and

FIG. 5 is an illustration of a graphical user interface for tracking consumer consumption in accordance with various embodiments.

### DETAILED DESCRIPTION

The embodiments presented herein are directed to systems, methods, and computer program products for aggregating e-receipt data, analyzing e-receipt data, and tracking consumer consumption for one or more transactions associated with the e-receipt data.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C+++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is essentially an e-receipt for the online purchase. The order confirmation includes detailed information regarding the products or services purchased. For example, in the case of a product, the order confirmation may include stock keeping unit “SKU” code level data, which may include parameters such as order number, order date, product description, product name, product quantity, product price, and the like. Further, other parameters associated with the e-receipt can include product image, hyperlink to the product image on merchant website, sales tax, shipping cost, order total, billing address, shipping company, shipping address, estimated shipping date, estimated delivery date, tracking number, and the like. The order confirmation also includes information about the merchant, such as name, address, phone number, web address, and the like. For most online transactions, the merchant will send at least one second communication confirming shipment of the order. The order shipment confirmation is typically also sent via email to the customer and typically includes the same information as the order confirmation, and in addition, shipping date, tracking number, and other relevant information regarding the order and shipment parameters.

Many merchants now also provide e-receipts to customers shopping at brick and mortar locations. In general, at the point of sale, the customer may have previously configured or may be asked at the time of sale as to whether she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

For the most part, order confirmations, shipping confirmations, e-receipts, and other electronic communications between merchants and customers are used only by the customer as proof of purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manages finances. A current drawback with online banking is that transactional level detail for a given purchase by the customer is limited. Despite the large amount of information sent by merchants to customers regarding purchases, merchants currently do not provide purchase details to financial institutions.

The only information provided to the financial institution is information about the merchant and an overall transaction amount. For example, if a financial institution customer purchases several clothing items from a merchant and uses a financial institution debit card, credit card or check, all that is provided to the financial institution is the merchant information and overall purchase. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budget tools. In general, budget tools divide expenses into various categories such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations.

Customer cash purchases are also problematic for integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data to obtain an understanding of the details of a given purchase transaction.

In light of the above, the current invention contemplates use of e-receipt data and other electronic communication data between a merchant and customer regarding a transaction in order to augment purchase transaction data in online banking. The general concept is to retrieve such electronic communications from the customer, parse the data in these electronic communications, and associate the data from the electronic communications with the corresponding online purchase transaction data.

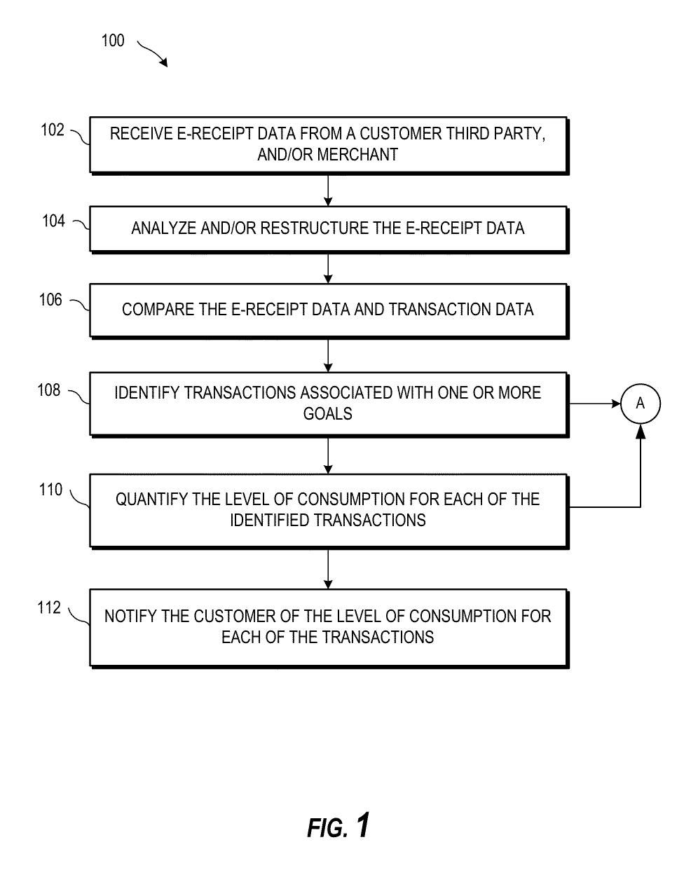

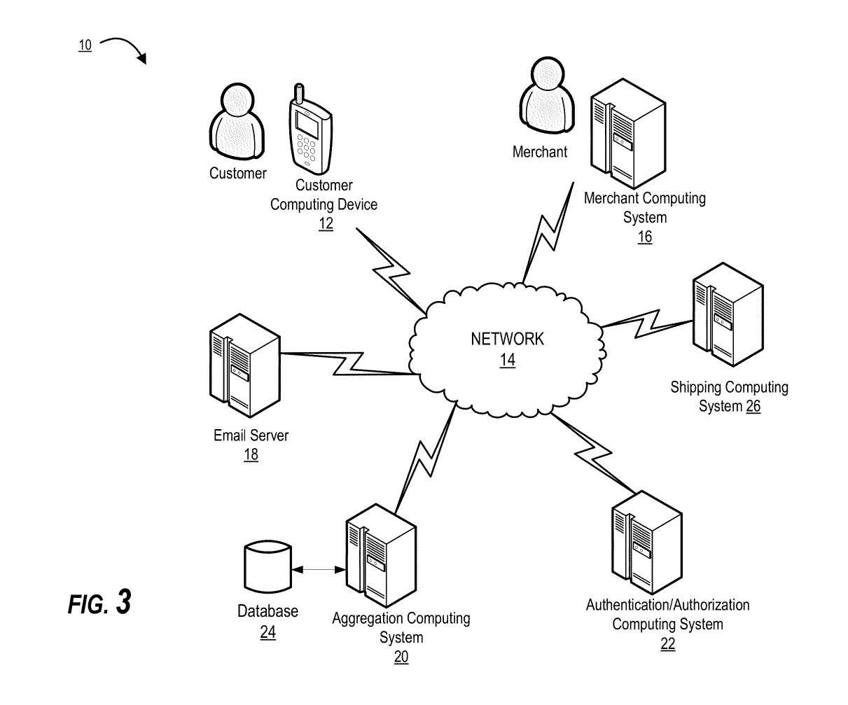

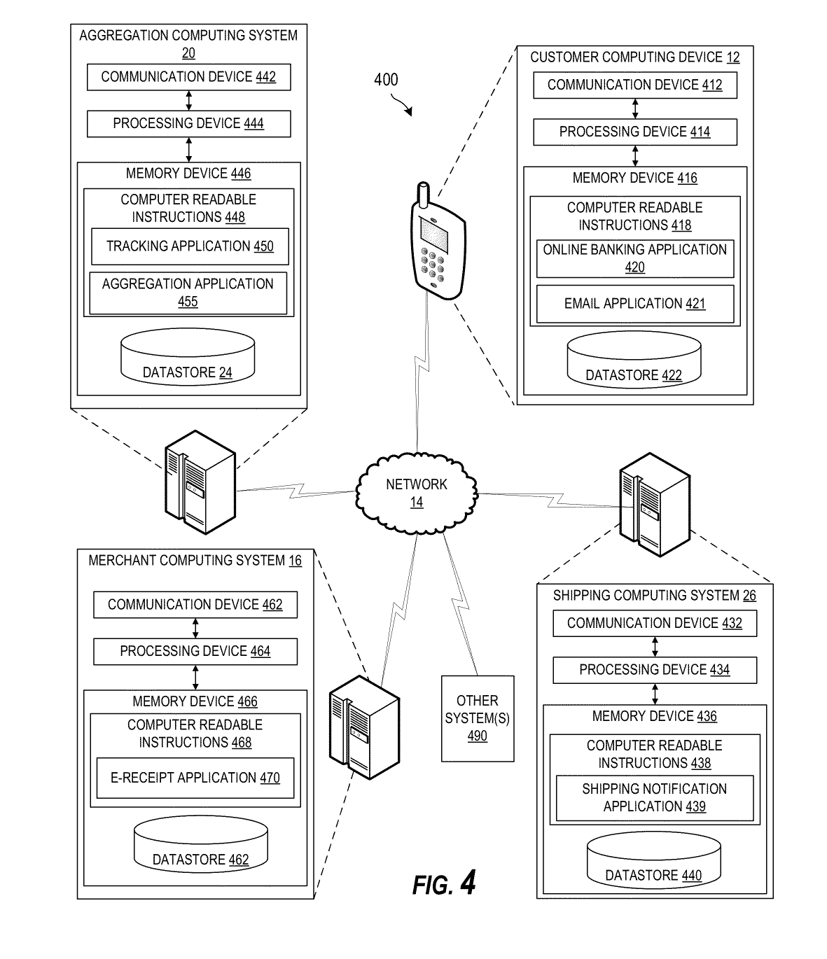

Referring now to the Figures, FIG. 1 illustrates a flowchart that provides an overview of a process 100 for providing e-receipt data, analyzing e-receipt data, and tracking consumption related to one or more purchase items. One or more devices, such as the one or more devices and/or one or more other computing devices and/or servers of FIGS. 3-4, can be configured to perform one or more steps of the process 100 or 200 described below. In some embodiments, the one or more devices performing the steps of the processes are associated with a financial institution. In other embodiments, the one or more devices performing the steps of the processes are associated with a merchant, business, partner, third party, credit agency, account holder, and/or user.

As illustrated at block 102, e-receipt data is received from a customer and/or merchant. For example, the customer may instruct the merchant to send at least a portion of the e-receipt data to the system of process 100. In other embodiments, the e-receipt data is received from a third party. The e-receipt data includes data associated (e.g., extracted) from a proof of purchase document, online confirmation communications, online customer accounts, shipping notices, order confirmation, and the like. The customer may, for example convert a paper receipt to an electronic document, forward an email containing a shipping notification, provide a purchase confirmation page from their online account, and the like. Retrieving e-receipt data is discussed in more detail below with regard to FIG. 3.

The e-receipt data includes detailed information regarding the products or services purchased. For example, in the case of a product, the order confirmation may include stock keeping unit “SKU” code level data. As used herein, “SKU level data” includes but is not limited to data associated with an identifier, code, or other data that embodies attributes associated with an item, such as a good or service. These attributes include, but are not limited to, manufacturer, product description, material, size, color, packaging, quantity, warranty terms, and the like. As described hereinabove, the e-receipt data can includes other parameters such as order number, order date, product name, product price, product image, hyperlink to the product image on merchant website, sales tax, shipping cost, order total, billing address, shipping company, shipping address, estimated shipping date, estimated delivery date, tracking number, and the like.

As illustrated at block 104, the e-receipt data is restructured. An initial barrier to integration of electronic communication data received by a customer from a merchant regarding a purchase transaction for inclusion into online banking is data format is incompatibility or differences in data structures between e-receipt data and other data such as transaction data. Online banking data, for example, is in a structured form. Financial institutions use a data structure conforming to Open Financial Exchange “OFX” specifications for the electronic exchange of financial data between financial institutions, businesses and customers via the Internet. E-receipts, such as electronic order confirmations, shipment confirmation, receipts, and the like, typically do not comply with a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form, which is described in more detail below with regard to FIG. 3.

As illustrated at block 106, the e-receipt data and the transaction data is compared. In cases where the e-receipt data is restructured for data compatibility, the restructured e-receipt data is compared to the transaction data. The transaction data includes transaction amounts, transaction dates, accounts used for the transaction, account balances before and after the transaction, account numbers, account types, account holder data, merchant data, and the like. Exemplary transactions include, for example, purchases, rebates, automatic bill pay, withdrawals, deposits, transfers, ATM related transactions, debit or credit card transactions, and the like.

In some embodiments, the e-receipt data and/or the transaction data is categorized. Each of the transaction data and the e-receipt data can be categorized by date, merchant, transaction amount, transaction channels, accounts, customers, and the like. By breaking down the transaction data and/or e-receipt data into segments, smaller chunks of data can be identified and cross-referenced.

As illustrated at block 108, transactions associated with one or more goals are identified based on the comparison. In further embodiments, the e-receipt data is matched to the transactions data to identify the transactions associated with the one or more goals. Any number of parameters can be used to match the e-receipt data to the transaction data. For example, the e-receipt data and the transaction data may be matched based on date, merchant identity, transaction location, and/or transaction amount. The system of process 100 may base the matching on a sequence of matches. For example, if the transaction data indicated that only one transaction occurred on a certain day, the system 100 may easily match the single transaction to a purchase occurring on the same day in the e-receipt data. If date or time information is missing or cannot be used to match a specific piece of transaction data to a specific piece of e-receipt data, then other data can be layered into the comparison. If the transaction data indicates that a purchase was made at 9:42 AM EST on January 3^{rd}, but not such data can be found in the e-receipt data, the system can ask the customer or merchant for input, determine if there was delay in the processing of the purchase, identify an error in the transaction data and/or e-receipt data, review the customer's transaction history, and the like. In still other cases, a customer may make several purchases via a single merchant on the same day using the same credit card for the same purchase amount. For example, it may be beneficial for a customer to buy the same or similar item in separate orders to obtain a discount. In such cases, the system may look to the shipping destinations in the e-receipt data, the product codes, or other e-receipt data to determine matches between the e-receipt data and the similar purchases.

The one or more goals include objectives associated with financial, social, environmental, health, and other personal goals. The one or more goals can include a decrease or increase in consumption of certain purchased items, spending, account balances, the number of transactions associated with preselected merchant or item, and the like. The one or more goals can include a maximum or minimum target transaction amount, savings amount, reward amount, quantity of purchase items, quality of purchase items, and the like. Exemplary goals include time periods, ranges, increases, decreases, maximums, or minimums associated with budget and savings categories; quantity levels associated with stock and projects; dietary goals; exercise goals; and the like.

In some embodiments, the one or more goals are based on customer input, transaction history and trends, account balances, customer demographic data, social media data, and the like. The customer, for example, may input preferences related to various goals such as a savings amount over a period of time, dietary restrictions, item quantity tracking, decrease in the amount of waste and carbon emissions attributable to the identified transactions, and so forth. In other examples, the system of process 100 analyzes the transaction data and/or the e-receipt data to identify purchasing trend indicative of a goal of the customer. Increases or decreases in account balances, number of purchases, or types of purchases can be used to predict future transactions and to identify the one or more goals. For example, decreases in restaurant transaction and increases in grocery store transaction and new purchases for fitness machinery may indicate that the customer is attempting to adopt a different lifestyle or save money by canceling gym memberships and by eating out less. In other examples, the system of process 100 analyzes the transaction data and/or the e-receipt data to identify purchases related to a particular goal in order to identify whether the customer should make additional purchases, use a different account, move money, and other actions related to the one or more goals. In this way, the system can determine the range, scope, amounts, and other parameters of the one or more goals.

In other instances, publically available information, such as the customer's social media data, government demographic data, real estate data, and other records, may be used to identify shifts in the customer's interests or requirements. Changing jobs, increases or decreases in household members or dependents, retirement, and new purchases such as a house or a new care may indicate that the customer has new financial goals related to these changes. For example, a customer over 65 may want to shift their emphasis to retirement goals while new parents may desire a new focus on product safety for their purchases. In this way, the system of process 100 can identify the one or more goals and the scope of the one or more goals, and present suggestions to the customers related to the identified one or more goals. For example, the customer may be presented, via an online banking account, with a list of possible goals that can be tied with the identified transactions.

As illustrated at block 110, the level of consumption for each of the identified transactions is quantified. The level of consumption includes calculations or estimates of purchase items consumed, energy consumed, calories used, money saved, money spent, money transferred, discounts used, rewards earned, and the like. The level of consumption can include quantity, range, percentages, maximums, minimums, and other calculations. Frequency of transactions over a period of time, merchant identities, product descriptions, or other SKU level data and transaction data can be used to calculate the level of consumption. In other embodiments, calculating the level of consumption is based on outside data. Outside data includes, for example, data extracted from public resources and government records as well as data received from applications synchronized with the system of process 100. For example, the customer may sync an online banking application with a diet, recipe, or other goal-related application.

In additional embodiments, a second level of consumption is calculated. The second level of consumption, in some embodiments, is associated with a period of time that predates the period of time associated with the first level of consumption associated with block 110. For example, the second level of consumption may include transactions that occurred during the previous year or month. In other embodiments, the second level of consumption is associated with a future period of time that will occur after the period of time associated with the first level of consumption discussed above. The system of process 100 can compare the first level with the second level of consumption to determine if the one or more goals have been accomplished for the current period of time or to determine if the one or more goals are likely to be accomplished in the future. If the first level of consumption is greater than or less than the previous level of consumption, the one or more goals may have been reached. A notification or recommendation, discussed in more detail below, may be provided to the customer if the one or more goals have not been reached, or are likely not to be reached in the future. Such notifications and recommendations may include, for example, transaction modifications for increasing the impact that transactions will have on the one or more goals. If one goal of the one or more goals has been reached for a given transaction or if the level of consumption is trending in the correct direction for reaching the one or more goals, the recommendation may advise the customer to continue doing the same transaction activity.

As illustrated at block 112, a notification of the level of consumption for each of the transactions is provided to the customer. The notification may be provided to the user via text, email, voice, video, or any other delivery method. Timing of the notification may be done in real time (e.g., substantially soon after a transaction is processed, e-receipt data received, and so forth), at regular intervals, or upon on request of the customer. In some cases, online banking statements or account updates may include the notification. In this way, the customer can keep track of personal consumption, spending, and savings.

In some embodiments, the system of process 100 determines the quantity, the frequency, and the time period that the customer should purchase certain items based on customer input, social media data, customer demographics, account data, the transaction data and/or the e-receipt data, and incorporates the quantity, the frequency, and the time period in the notification. For example, the number of household members; the distance between home, work, and school; the ages of each household member; and the model and number of cars associated with the household can be combined with the amount of gasoline purchased per week and the cost of the gasoline in order to determine when and how frequently the members of the household should purchase gas. Such information can be included in the notification or inputted in a recommendation as detailed below. The notification can be provided to the customer when the customer does not need or want a recommendation.

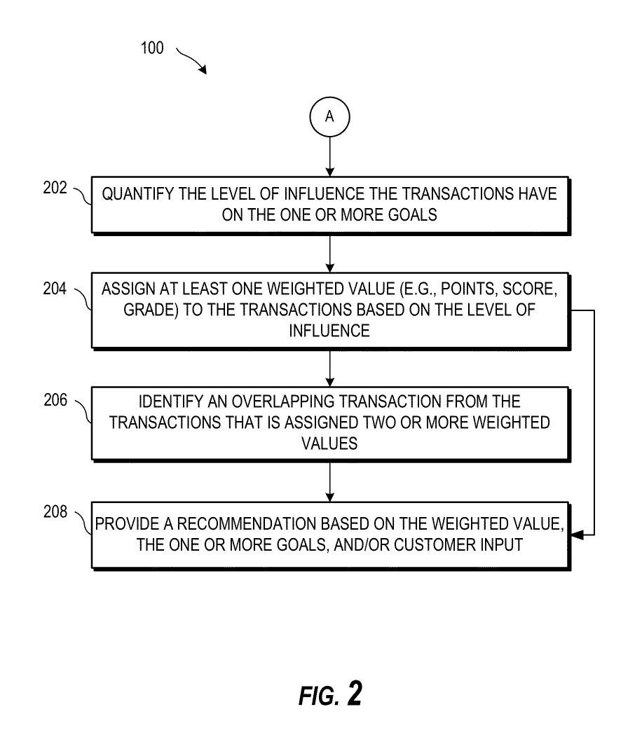

Referring now to FIG. 2, the process 100 is further illustrated. As illustrated at block 202, the level of influence or impact the transactions have on the one or more goals is quantified. The level of influence or impact is used to determine how much each transaction influences the outcome of the one or more goals, such as the amount of time, the type of transactions, or amount needed to accomplish the one or more goals; the speed in reaching the one or more goals; whether the transaction activity of the identified transaction are trending in the right direction to accomplish the one or more goals; and the like. The level of impact can be calculated as a range, a quantity, a frequency, or a quality associated with a purchase item. In some embodiments, the level of impact is based on the level of consumption for each of the transactions. For example, if the goal is to maximize purchases in a particular geographic area, determining how quickly the goal can be reached, and the amount of time needed and the number of purchases remaining in order to reach the goal may be based on the level of consumption. In other embodiments, the level of impact is based on the purchase history, purchase trends, and the outside data. Purchase trends, such as buying wine an average of twice a month, can be tracked over a certain period of time and deviations from the trend can be identified in order to more accurately estimate the level of impact. If over the past three years the customer has bought two bottle of wine every month through February to October, but has bought over 5 bottles of wine during the months of November to January, the system of process 100 can predict the quantity and monetary amounts of wine that will purchased over the course of the upcoming year. Outside data such as market trends, economic reports, and government data can be used to, for example, adjust prices, item quantities, and interest rates.

As illustrated at block 204, at least one weighted value is assigned to one or more of the transactions based on the level of influence. Exemplary weighted values include points, scores, grades, certifications, ratings, and any other indicator. In some embodiments, the transactions are categorized into one or more groups, and certain types of weighted values are assigned to each category. Each transaction may be assigned to one or more categories. For example, yogurt purchases may be assigned to both a recipe category and a fitness category and bottled water may be assigned to a diet category and an energy consumption category. Based on the categories, the transactions in the categories are assigned a certain type of weighted values.

The weighted values may be based on government sponsored rating systems, a point scale, grading scales, industry accepted scores, and the like. In some embodiments, the system of process 100 creates the weighted value based on a point system. For example, transaction involving amounts of $100 may be assigned 1 point based on the category, the item purchased, the merchant associated with the transaction, and the like. In other cases, the outside data is used to assign the weighted value. For example, if a government agency designates as certain score for units per time period for energy consumption (e.g., gallons/month), the system of process 100 can calculate the customer's energy consumption and assign the government sponsored scoring scale to the energy consumption transactions. In other examples, synchronized data received from one or more applications may be used to assign each transaction a weighted value based on the scoring scale associated with each application. SKU code of each transaction can be matched to SKU code in the application, or the product description can be matched to similar key terms in the synchronized data. In this way, the customer can review not only a detailed transactions analysis that incorporates SKU level data, but can also easily review goal related data as well.

As illustrated at block 206, an overlapping transaction is identified from the transactions, where the overlapping transaction is assigned two or more weighted values. In some embodiments, the two or more weighted values are associated with different goals. In other embodiments, the overlapping transaction is assigned to at least two categories. The two or more weighted values can be the same type of weighted value or different types of weighted value. In other embodiments, the two or more weighted values can have the same weighted value or different weighted values. For example, the overlapping transaction may have one point value and be in one category and also have the same point value in a second category. The scoring basis in the first category may be different than the scoring basis in the second category, or the scoring basis may be the same. For example, if the customer buys 10 items that cost $10 each, the scoring basis associated with a budget goal may be 1 point for every $10 and the scoring basis for a stock keeping category may be 1 point for every item purchased. In either case, the value of the points would be the same. In other embodiments, the weighted value in category is based on the weighted value in another category. For example, if a smart phone is assigned a grade of A in a functionality category, the smart phone may be assigned a higher energy efficiency rating than would normally be the case because the smart phone is able to function in many different capacities such that energy consumption of other devices is diminished.

As illustrated at block 208, a recommendation is provided based on the weighted value, the one or more goals, and/or customer input. The recommendation may include, for example, an increase in a certain credit card use if the one or more goals are related to increases in rewards, a decrease in certain purchase items if the customer desires to accomplish a certain weight loss goal, and the like. For example, the recommendation may be provided when the user has entered a grocery store based on geographic data (e.g., location coordinates from a GPS mapping system of a mobile device) such that the customer can have helpful recommendations in making purchases.

In cases where the transaction cannot be altered, the system may suggest an alternate path. For example, a customer may not be able to decrease spending on gas because geographical data where the customer lives may indicate that there is no public transportation or the customer input indicates that gas consumption cannot be decreased. In such cases, the system may suggest decreasing other sources of carbon emissions or waste such as recommendations directed to purchasing a water filter and decreasing bottled water purchases, purchasing more energy efficient appliances. The recommendation may also be directed to non-transaction related suggestions such as altering heating and cooling practices. The system may also eliminate certain transaction from the scoring process altogether based on customer input.

In some embodiments, the recommendation is based on the weighted values of the overlapping transaction. The system of process 100 can determine that the first weighted value is greater than the second weighted value. In some embodiments, the recommendation is provided to the customer based on the first weighted value. If a speaker system has a score of 95 in a reliability and satisfaction category, but is only rated 5 in a 10 point scale based on price in a budget category, the recommendation may still factor in parameters associated with the reliability and satisfaction category, such as a lengthy warranty and good customer service reviews, in recommending that the customer purchase the speaker system.

In other embodiments, the system of process 100 provides the recommendation based the second weighted value, i.e., the lower weighted value associated with the overlapping transaction. In such cases, the lower weighted value may have more impact on the one or more goals than the greater weighted value. For example, if an overlapping transaction such as a hair salon service purchase has a score of 33 out of 35 in a budget category because it is at the lower range in hair salon prices in a geographic area, but has a grade of C− in a sanitation category, the recommendation may suggest a different hair salon establishment. In other examples, the lower weighted value, depending on the scoring system and scale used to determine the weighted value and the one or more goals, may indicate a positive outcome. A carbon footprint category, for example, may be setup such that a lower point value for any given transaction indicates a positive impact on the environment, and a greater point value indicates larger carbon emission when using the transaction item and a more negative impact on the environment.

FIG. 3 is a diagram of an operating environment 10 according to one embodiment of the present invention for retrieval of electronic communications relating to customer purchase transactions, parsing of data within such electronic communications into structured data, inclusion of such data into online banking, and tracking consumer consumption. As illustrated a consumer maintains one or more computing devices 12, such as a PC, laptop, mobile phone, tablet, television, or the like, that is network enabled for communicating across a network 14, such as the Internet, wide area network, local area network, Bluetooth network, near field network, or any other form of contact or contactless network. Also, in the operating environment, are one or more merchant computing systems 16 that are network enabled. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data including parameters associated with the product such as type/category, size, color, and the like, as well purchase price information, information associated with the merchant, and the like. The merchant computing system may also send other subsequent communications such as communications confirming shipment of the order, which typically includes the same information as the purchase order confirmation, and in addition, shipping date, tracking number, and other relevant information regarding the order. In the context of an in-store purchase, the merchant computing system may send an electronic receipt comprising information similar to that of the purchase order confirmation. In some instances, the customer may actually receive a paper receipt, which the customer may choose to scan into an electronic form and save in a storage device associated with the customer computing device 12. In the description herein, the term e-receipt may be used generically to refer to any communication or document provided by a merchant to a customer relating to a purchase transaction.

For a plurality of different purchase transactions, a customer may include purchase transaction related data (e.g., order confirmations, shipping confirmations, e-receipts, scanned receipts, typed or handwritten notes, invoices, bills of sale, and the like) in various locations and in various forms. The purchase related data could be stored in a storage device associated with the customer computing device 12, or in an email server 18, or in a customer's account at the merchant's computing system 16. Furthermore, as mentioned, the purchase transaction related information is in an unstructured format. Each merchant may use a customized reporting format for the communications, whereby various data relating to the purchase transaction may be placed in different sequences, different locations, different formats, etc. for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, and in some cases, track consumption, the operating environment further comprises an aggregation computing system 20. The aggregation computing system 20 is operatively connected to at least one of the customer computing device 12, the merchant computing system 16, the authentication/authorization computing system 22, and/or the email server 18 via the network 14. The aggregation computing system 20 is configured to initially search and locate electronic communications associated with purchase transactions made by the customer, in for example, the customer's email, computer storage device, online accounts, and the like. For this purpose, the system may optionally include an authentication/authorization computing system 22 that comprises security IDs and passwords and other security information associated with the customer for accessing customer's email, storage devices, and customer online accounts.

Regarding email extraction, aggregation computing system 20 initially gains access to the customer's email accounts and retrieves email message headers comprising data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “e-receipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text contained in email message bodies is un structured (as opposed to the structured tagged elements in a hypertext markup language (HTML) web page which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation computing system 20. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. Where the email is an e-receipt from a brick and mortar purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, typed or handwritten notes, invoices, bills of sale, or other e-receipt data. As mentioned, a customer may scan and save paper receipts in a storage device or print and save purchase order and shipping confirmation communications sent to the customer by the merchant via a web page. In this instance, the aggregation computing system 20 may first perform optical character recognition “OCR” on the scanned or printed receipts prior to performing the processing performed above. Further, a customer may maintain an online account with a merchant containing purchase data information. In this instance, the aggregation computing system 20 will access the data online via communication with merchant computing system 16 to retrieve this data. The aggregation computing system 20 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, etc. to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Other extraction parsers may be used, such as regular expression extraction, which can be used as a brute force pattern matching approach across the purchase information record. With this technique, each word in a given purchase order record is matched against a set of rules. If the rules are met, the piece of text matching the set of rules is returned. For example, shipping companies frequently use a 21 digit tracking number beginning with “1Z” or “91.” The aggregation computing system may scan an entire purchase information record to find a 21 digit number with “1Z” or “91” as the first 2 digits. The matched text can then be extracted and used to determine shipping information.

In another embodiment, an HTML document object model (DOM) approach may be used to parse purchase data records. For example, the message body of an email shipping notification may contain HTML code with tags for order, shipping and/or tracking information. The aggregation computing system may use these tags to identify the shipping and/or tracking information for extraction.

Once relevant information is extracted from communications between the customer and merchant regarding purchase transactions, it is stored in purchase data records in a structured database 24.

As is understood, once the purchase transaction data has been extracted, various information regarding a particular purchase transaction is now known, such as merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. This data can be further enriched with additional and/or updated information associated with products or services within the data. For example, the data may be enriched with updated shipping and delivery information from a shipping company computer system 26, product images, information about product returns, warranty information, recall information, and the like. In particular, the aggregation computing system may (1) communicate with the merchant and/or shipping company to update the shipping and delivery information extracted and stored in the database, (2) may search the merchant or the web in general to retrieve product images, and/or (3) communicate with merchant for return policies, warranties, insurance, recalls, and the like.

The above is a description of an aggregation computing system according to one embodiment of the present invention. An example of an aggregation computing system is described in U.S. Published Patent Application No. 2013/0024525 titled Augmented Aggregation of Emailed Product Order and Shipping Information, the contents of which are incorporated herein by reference.

Referring now to FIG. 4, a block diagram illustrates an environment 400 for tracking consumer consumption. The environment 400 includes the customer computing device 12, the aggregation computing system 20, the shipping computing system 26, and the merchant computing system 16 of FIG. 3. The environment 400 further includes one or more other systems 490 (e.g., the authentication/authorization system 22, the email server 18, a partner, agent, contractor, other user, third party systems, external systems, internal systems, and so forth). The systems and devices communicate with one another over the network 14 and perform one or more of the various steps and/or methods according to embodiments of the disclosure discussed herein.

The customer computing device 12, the aggregation computing system 20, the shipping computing system 26, and the merchant computing system 16 each includes a computer system, server, multiple computer systems and/or servers or the like. The aggregation computing system 20, in the embodiments shown has a communication device 442 communicably coupled with a processing device 444, which is also communicably coupled with a memory device 446. The processing device 444 is configured to control the communication device 442 such that the aggregation computing system 20 communicates across the network 14 with one or more other systems. The processing device 444 is also configured to access the memory device 446 in order to read the computer readable instructions 448, which in some embodiments includes a tracking application 450 for tracking consumption and an aggregation data application 455. The memory device 446 also includes a datastore 24 or database for storing pieces of data that can be accessed by the processing device 444. In some embodiments, the datastore 24 includes online session data such as transaction data, user input, and device tracking data, as well as login data, device registration data, user data, and the like.

As used herein, a “memory device” generally refers to a device or combination of devices that store one or more forms of computer-readable media and/or computer-executable program code/instructions. Computer-readable media is defined in greater detail below. For example, in one embodiment, the memory device 446 includes any computer memory that provides an actual or virtual space to temporarily or permanently store data and/or commands provided to the processing device 444 when it carries out its functions described herein.

The customer computing device 12 includes a communication device 412 communicably coupled with a processing device 414, which is also communicably coupled with a memory device 416. The processing device 414 is configured to control the communication device 412 such that the customer computing device 12 communicates across the network 14 with one or more other systems. The processing device 414 is also configured to access the memory device 416 in order to read the computer readable instructions 418, which in some embodiments includes an online banking application 420 and an email application 421. The memory device 416 also includes a datastore 422 or database for storing pieces of data that can be accessed by the processing device 414.

The shipping computing system 26 includes a communication device 432 communicably coupled with a processing device 434, which is also communicably coupled with a memory device 436. The processing device 434 is configured to control the communication device 432 such that the shipping computing device 322 communicates across the network 14 with one or more other systems. The processing device 434 is also configured to access the memory device 436 in order to read the computer readable instructions 438, which in some embodiments includes a shipping notification application 439. The memory device 436 also includes a datastore 440 or database for storing pieces of data that can be accessed by the processing device 434.

The merchant computing system 16 includes a communication device 462 communicably coupled with a processing device 464, which is also communicably coupled with a memory device 466. The processing device 464 is configured to control the communication device 462 such that the shipping computing device 322 communicates across the network 14 with one or more other systems. The processing device 464 is also configured to access the memory device 466 in order to read the computer readable instructions 468, which in some embodiments includes an e-receipt application 470. The memory device 466 also includes a datastore 462 or database for storing pieces of data that can be accessed by the processing device 464.

In some embodiments, the online banking application 420, the shipping notification application 439, and/or the e-receipt application 470 interact with the tracking application 450 and/or aggregation application 455 to aggregate electronic data and track consumption for the customer associated with the device 12 as described herein.

The applications 420, 439, 450, 455, and 470 are used for instructing the processing devices 414, 434, 444 and 464 to perform various steps of the methods discussed herein, and/or other steps and/or similar steps. In various embodiments, one or more of the applications 420, 439, 450, 455, and 470 are included in the computer readable instructions stored in a memory device of one or more systems or devices other than the systems 18, 20, 16, 26, and 490 and the device 12. For example, in some embodiments, the application 420 is stored and configured for being accessed by a processing device of one or more third party systems (e.g., the other systems 490) connected to the network 14. In various embodiments, the applications 420, 439, 450, 455, and 470 are stored and executed by different systems/devices are different. In some embodiments, the applications 420, 439, 450, 455, and 470 are stored and executed by different systems may be similar and may be configured to communicate with one another, and in some embodiments, the applications 420, 439, 450, 455, and 470 may be considered to be working together as a singular application despite being stored and executed on different systems.

In various embodiments, one of the systems discussed above, such as the aggregation computing system 20, is more than one system and the various components of the system are not collocated, and in various embodiments, there are multiple components performing the functions indicated herein as a single device. For example, in one embodiment, multiple processing devices perform the functions of the processing device 444 of the aggregation computing system 20 described herein. In various embodiments, the aggregation computing system 20 includes one or more of the external systems and/or any other system or component used in conjunction with or to perform any of the method steps discussed herein. For example, the aggregation computing system 20 may include a aggregation computing system, a credit agency system, and the like.

In various embodiments, the aggregation computing system 20, the shipping computing system 26, the merchant system 16, the customer computing device 12, the other system 490, and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 100, the other methods discussed above, or other methods, processes or steps discussed herein or not discussed herein.

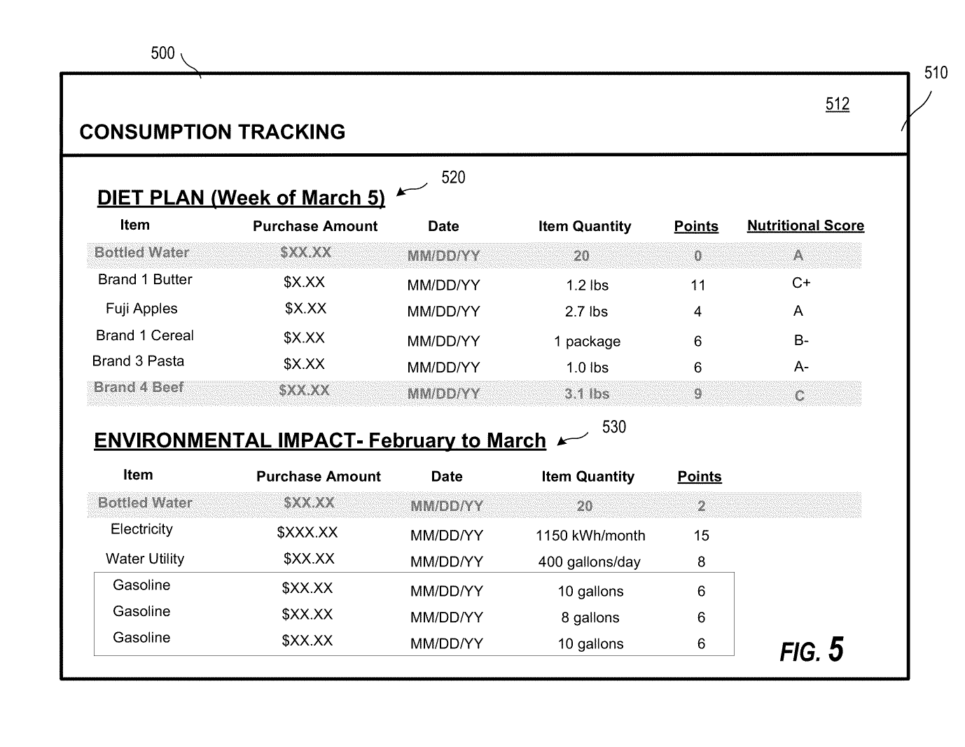

Referring now to FIG. 5, an exemplary graphical user interface (GUI) 510 of a computing device 500 (e.g., the customer computing device 12 in FIG. 3) is illustrated. The GUI 500 includes a consumption tracking statement 512. In some embodiments, a customer and/or user of the mobile device 500 logs into an online banking account to access the consumption tracking statement 512. The consumption tracking statement 512, in the illustrated embodiment, is divided into a plurality of categories, including a diet plan category 520 and an environmental impact category 530. Each category includes columns for purchase items, purchase amounts, date of purchase, quantity of items purchased, and one or more columns for a weighted value.

The diet plan category 520 includes purchases made during a particular week that are associated with the goal of weight loss. The customer is given two types of weighted values for the diet plan category. The points column assigns a certain number of points for every food purchase. In some embodiments, the customer is allowed to eat foods having a certain total number of points per day. To supplement the point values, a nutritional score is also assigned to each food purchase and is displayed next to the points column. In the illustrated embodiment, the method for assigning points is different from the method for assigning the nutritional score. The nutritional score is based on a method of valuing the overall nutrition of a food item, and may vary based on the ingredients in the food, food processing, brand, and the like. Even though a certain food item may have the same point value regardless of the brand of the food item, the nutritional score may vary based on the manufacturer's ingredients or preparation methods. Although not shown in the illustrated embodiment, additional information can be included in the diet plan category 520 such as the nutritional breakdown of the food such as calories, fat content, types of fat, protein, and the like. Such data may be imported from a health and fitness application that is synched to the customer's online banking account application. The points column and the nutritional score column contain hyperlinks that the customer can click to view how each weight value system works and how the weighted values are assigned.

Further shown in FIG. 5 are highlighted rows in the diet plan category 520 and the environmental impact category 530. The rows for bottled water are highlighted to indicate that the bottled water transaction is an overlapping transaction that is assigned to two or more categories. In the illustrated embodiment, the bottle water transaction occurs in both the diet plan category and the environmental impact category. The highlighted row that includes the Brand 4 Beef transaction occurs in the diet plan category 520 and a recipe category (not shown).

The environmental impact category 530 includes transactions that occurred during a one month period and is directed to reducing the customer's carbon footprint, landfill waste, and energy consumption. The bottled water transaction point values between the two categories are different due to the difference in strategies for assigning points and the difference in the goals.

In additional embodiments, the row directed to gasoline purchases are boxed to indicate that these transactions are not used in a recommendation (not shown) for the environmental impact category 530. The system may allow the customer to make changes to add the gasoline purchases back into the recommendation if the customer so desires. The recommendation may be viewed by, for example, double clicking on the environmental impact category 530. The recommendation may include suggestions for eliminating or reducing water bottle waste, energy consumption, and water consumption. For example, the recommendation may provide the user with a cost analysis of using a water filtration system and reusable containers versus buying bottled water, the offset amount in energy savings due to appliance upgrades and house upgrades, and the like. Further, the recommendation may also provide links to suggested product recommendations (e.g., a water filtration system, LED lighting, and so forth), merchants, environmental articles, and the like.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for tracking consumer consumption of purchased items, the system comprising:
a computer apparatus including a processor and a memory; and
a tracking software module stored in the memory, comprising executable instructions that when executed by the processor cause the processor to:
receive e-receipt data comprising stock keeping unit (SKU) level data associated with a transaction from a customer, wherein the e-receipt data comprises at least one of a product information, a merchant information, transaction information, and shipping information;
retrieve a transaction data associated with the transaction from a financial institution account history of the customer, wherein the transaction data comprises at least one of transaction amount, transaction date, an account balance before execution of the transaction, an account balance after execution of the transaction, and a merchant associated with the transaction;
determine that data structure of the received e-receipt data and the data structure of the retrieved transaction data are dissimilar;
restructure the e-receipt data to ensure that the data structure of the e-receipt data is compatible with the data structure of the transaction data;
compare the e-receipt data with transaction data, wherein comparing further comprises categorizing e-receipt data and the transaction data based on at least a transaction date, a merchant associated with the transaction, and a transaction amount;
match the e-receipt data to one or more transactions based on the comparison, wherein the e-receipt data is matched with the one or more transactions based on at least one of a transaction date, a merchant identity, a transaction location, and a transaction amount;
identify transactions associated with one or more customer goals based on the SKU level data, wherein the one or more customer goals comprises at least one of a financial goal, a social goal, an environmental goal, and a health goal, wherein the transactions are categorized based on at least a transaction date, merchant, transaction amount, and transaction channels;
calculate a first quantity of consumption for each of the identified transactions;
determine the level of influence that each transaction has on the one or more customer goals, wherein the level of influence determines how much each of the one or more transactions influences the outcome of the one or more customer goals;
assign at least one weighted value to each of the transactions based on the level of influence based on at least the category associated with each of the identified transactions; and
provide a recommendation to the customer based on the weighted value and the one or more customer goals.

2. The system of claim 1, wherein the executable instructions further cause the processor to:
identify an overlapping transaction from the transactions that is assigned two or more weighted values, wherein each of the two or more weighted values are associated with different goals; and
determine that the first weighted value is greater than the second weighted value.

3. The system of claim 2, wherein the executable instructions further cause the processor to:
provide a recommendation to the customer based on the first weighted value.

4. The system of claim 2, wherein the executable instructions further cause the processor to:
provide a recommendation to the customer based on the second weighted value.

5. The system of claim 1, wherein the executable instructions further cause the processor to:
allow the user to synchronize one or more applications with the system;
import data from the one or more applications; and
assign at least one weighted value to each of the transactions based on the imported data.

6. The system of claim 1, wherein the executable instructions further cause the processor to:
receive customer input; and
identify the one or more customer goals based on the input.

7. The system of claim 1, wherein the executable instructions further cause the processor to:
calculate a second quantity of consumption associated with transactions occurring during a second period of time that predates the first period of time; and
compare the first quantity of consumption and the second quantity of consumption.

8. The system of claim 7, wherein the executable instructions further cause the processor to:
determine that the one or more customer goals have been reached based on the comparison of the first quantity of consumption and the second quantity of consumption.

9. The system of claim 7, wherein the executable instructions further cause the processor to:
determine that the one or more customer goals have not been reached based on the comparison of the quantities of consumption; and
provide a recommendation to the customer comprising transaction modifications.

10. A computer program product for tracking consumer consumption for purchased items, the computer program product comprising:
a non-transitory computer readable storage medium having computer readable program code embodied therewith, the computer readable program code comprising:
computer readable program code to receive e-receipt data comprising stock keeping unit (SKU) level data associated with a transaction from a customer, wherein the e-receipt data comprises at least one of a product information, a merchant information, transaction information, and shipping information;
computer readable program code to retrieve a transaction data associated with the transaction from a financial institution account history of the customer, wherein the transaction data comprises at least one of transaction amount, transaction date, an account balance before execution of the transaction, an account balance after execution of the transaction, and a merchant associated with the transaction;
computer readable program code to determine that data structure of the received e-receipt data and the data structure of the retrieved transaction data are dissimilar;
computer readable program code to restructure the e-receipt data to ensure that the data structure of the e-receipt data is compatible with the data structure of the transaction data;
computer readable program code to compare the e-receipt data with transaction data, wherein comparing further comprises categorizing e-receipt data and the transaction data based on at least a transaction date, a merchant associated with the transaction, and a transaction amount;
computer readable program code to match the e-receipt data to one or more transactions based on the comparison, wherein the e-receipt data is matched with the one or more transactions based on at least one of a transaction date, a merchant identity, a transaction location, and a transaction amount;
computer readable program code to identify transactions associated with one or more customer goals based on the SKU level data, wherein the one or more customer goals comprises at least one of a financial goal, a social goal, an environmental goal, and a health goal, wherein the transactions are categorized based on at least a transaction date, merchant, transaction amount, and transaction channels;
computer readable program code to calculate a first quantity of consumption for each of the identified transactions;
computer readable program code to determine the level of influence that each transaction has on the one or more customer goals, wherein the level of influence determines how much each of the one or more transactions influences the outcome of the one or more customer goals;
computer readable program code to assign at least one weighted value to each of the transactions based on the level of influence based on at least the category associated with each of the identified transactions; and
computer readable program code to provide a recommendation to the customer based on the weighted value and the one or more customer goals.

11. The computer program product of claim 10, further comprising computer readable program code configured to identify an overlapping transaction from the transactions that is assigned two or more weighted values, wherein each of the two or more weighted values are associated with different goals, determine that the first weighted value is greater than the second weighted value.

12. The computer program product of claim 10, further comprising computer readable program code configured to provide a recommendation to the customer based on the first weighted value or the second weighted value.

13. The computer program product of claim 10, further comprising computer readable program code configured to calculate a second quantity of consumption associated with transactions occurring during a second period of time that predates the first period of time, compare the first quantity of consumption and the second quantity of consumption , determine that the one or more customer goals have not been reached based on the comparison of the quantities of consumption; and provide a recommendation to the customer comprising transaction modifications.

14. A computer-implemented method for tracking consumer consumption for purchased items, the method comprising:
receiving e-receipt data comprising stock keeping unit (SKU) level data associated with a transaction from a customer, wherein the e-receipt data comprises at least one of a product information, a merchant information, transaction information, and shipping information;
retrieving a transaction data associated with the transaction from a financial institution account history of the customer, wherein the transaction data comprises at least one of transaction amount, transaction date, an account balance before execution of the transaction, an account balance after execution of the transaction, and a merchant associated with the transaction;
determining that data structure of the received e-receipt data and the data structure of the retrieved transaction data are dissimilar;
restructuring the e-receipt data to ensure that the data structure of the e-receipt data is compatible with the data structure of the transaction data;
comparing the e-receipt data with transaction data, wherein comparing further comprises categorizing e-receipt data and the transaction data based on at least a transaction date, a merchant associated with the transaction, and a transaction amount;
matching the e-receipt data to one or more transactions based on the comparison, wherein the e-receipt data is matched with the one or more transactions based on at least one of a transaction date, a merchant identity, a transaction location, and a transaction amount;
identifying transactions associated with one or more customer goals based on the SKU level data, wherein the one or more customer goals comprises at least one of a financial goal, a social goal, an environmental goal, and a health goal, wherein the transactions are categorized based on at least a transaction date, merchant, transaction amount, and transaction channels;
calculating a first quantity of consumption for each of the identified transactions;
determining the level of influence that each transaction has on the one or more customer goals, wherein the level of influence determines how much each of the one or more transactions influences the outcome of the one or more customer goals;
assigning at least one weighted value to each of the transactions based on the level of influence based on at least the category associated with each of the identified transactions; and
providing a recommendation to the customer based on the weighted value and the one or more customer goals.

15. The computer-implemented method of claim 14, further comprising:
identifying, by a processor, an overlapping transaction from the transactions that is assigned two or more weighted values, wherein each of the two or more weighted values are associated with different goals; and
determining, by a processor, that the first weighted value is greater than the second weighted value.

16. The computer-implemented method of claim 15, further comprising providing a recommendation to the customer based on the first weighted value.

17. The computer-implemented method of claim 15, further comprising:
allowing the user to synchronize one or more applications with the system;
importing data from the one or more applications; and
assigning at least one weighted value to each of the transactions based on the imported data.

18. The computer-implemented method of claim 14, further comprising:
receiving customer input; and
identifying the one or more customer goals based on the input.

19. The computer-implemented method of claim 14, further comprising:
calculating, by a processor, a second quantity of consumption associated with transactions occurring during a second period of time that predates the first period of time; and
comparing, by a processor, the first quantity of consumption and the second quantity of consumption; and
determining, by a processor, that the one or more customer goals have been reached based on the comparison.

20. The computer-implemented method of claim 19, further comprising:
determining that the one or more customer goals have been reached based on the comparison of the first quantity of consumption and the second quantity of consumption.
